(19) United States
(12) Patent Application Publication
(10) Pub. No.: US 2013/0210522 A1
(43) Pub. Date: Aug. 15, 2013

(54) DATA CENTER ARCHITECTURE FOR REMOTE GRAPHICS RENDERING

(71) Applicant: CiiNOW, Inc., (US)

(72) Inventor: Makarand DHARMAPURIKAR, Fremont, CA (US)

(73) Assignee: CIINOW, INC., Mountain View, CA (US)

(21) Appl. No.: 13/739,473

(22) Filed: Jan. 11, 2013

Related U.S. Application Data
(60) Provisional application No. 61/585,851, filed on Jan. 12, 2012.

(51) Int. Cl. A63F 13/12

(52) U.S. Cl. CPC A63F 13/12
USPC 463/31

(57) ABSTRACT

A data center architecture for remote rendering includes a hardware processor, a memory, a storage device, a graphics processor, a virtual machine monitor functionally connected to the hardware processor, memory, and storage device, one or more virtual machine game servers functionally connected to the virtual machine monitor, each virtual machine game server including a virtual processor, a virtual memory, a virtual storage, a virtual operating system, and a game binary executing under the control of the virtual operating system; a virtual machine rendering server functionally connected to the virtual machine monitor and functionally connected to the graphics processor, the virtual machine rendering server including: a virtual memory, a virtual storage, a virtual operating system, and one or more renderers.

### CROSS-REFERENCE TO RELATED APPLICATIONS

The present application claims the benefit of U.S. Provisional Application No. 61/585,851, filed Jan. 12, 2012, which is hereby incorporated by reference in its entirety.

### FIELD OF THE INVENTION

The invention relates to the field of remote graphics rendering.

### BACKGROUND

Remote graphics rendering is typically used in the context of gaming. Remote graphics rendering allows a user of a client device to interact with a game that is running at a remote location (e.g., data center). User inputs may be transmitted to the data center, where game instructions are generated and graphics are rendered and transmitted back to the client device.

One approach for implementing remote graphics rendering involves using virtualization of hardware resources at the data center to service different client devices. Prior approaches for virtualizing hardware resources fail to provide independent scalability of graphics processing units (GPUs) and central processing units (CPUs) depending on operational demand. Therefore, there is a need for an improved data center architecture for remote graphics rendering which addresses these and other problems with prior implementations.

### SUMMARY

Embodiments of the invention concern a data center architecture for remote rendering that includes a hardware processor, a memory, a storage device, a graphics processor, a virtual machine monitor functionally connected to the hardware processor, memory, and storage device, one or more virtual machine game servers functionally connected to the virtual machine monitor, each virtual machine game server including a virtual processor, a virtual memory, a virtual storage, a virtual operating system, and a game binary executing under the control of the virtual operating system; a virtual machine rendering server functionally connected to the virtual machine monitor and functionally connected to the graphics processor, the virtual machine rendering server including: a virtual memory, a virtual storage, a virtual operating system, and one or more renderers.

### BRIEF DESCRIPTION OF THE DRAWINGS

In order that the present invention is better understood data center architectures in accordance with the invention will now be described, by way of example only, with reference to the accompanying drawings in which like reference numerals are used to denote like parts, and in which:

FIG. 1 illustrates a block diagram of a client-server architecture.

FIG. 2 illustrates a block diagram of a prior approach data center architecture.

FIG. 3A illustrates a block diagram of a data center architecture according to some embodiments.

FIG. 3B illustrates a block diagram of another data center architecture according to some embodiments.

FIG. 3C illustrates a block diagram of another example data center architecture according to some embodiments.

FIG. 4A illustrates a block diagram of a virtual machine game server of the data center architecture of FIG. 3A according to some embodiments.

FIG. 4B is a flow diagram illustrating a method for utilizing a virtual machine game server according to some embodiments.

FIG. 5A illustrates a block diagram of a rendering server of the data center architecture of FIG. 3A according to some embodiments.

FIG. 5B illustrates a block diagram of a virtual machine rendering server of the data center architecture of FIG. 3B according to some embodiments.

FIG. 5C illustrates a block diagram of a virtual machine rendering server of the data center architecture of FIG. 3C according to some embodiments.

FIG. 5D is a flow diagram illustrating a method for utilizing a rendering server according to some embodiments.

FIG. 6A illustrates a selective configuration of the data center architecture of FIG. 3A according to some embodiments.

FIG. 6B illustrates a selective configuration of the data center architecture of FIG. 3B according to some embodiments.

FIG. 6C illustrates a selective configuration of the data center architecture of FIG. 3A according to some embodiments.

### DETAILED DESCRIPTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

According to some embodiments, data center architectures for remote graphics rendering are provided in which one or more virtual machine game servers are functionally connected to a virtual machine monitor which is functionally connected to a hardware processor and also in which a virtual machine rendering server is functionally connected to the virtual machine monitor and also functionally connected to a graphics processor. Each virtual machine game server may provide CPU processing for a game associated with a particular client and the virtual machine rendering server may provide GPU processing for a plurality of games associated with a plurality of clients. The virtual machine game servers may communicate with the virtual machine rendering server over a network.

In this way, the embodiments of the invention provide efficient scalability of the data center architecture, since the data center architecture may be selectively configured to independently add one or more GPUs or one or more CPUs depending on operational demand. Furthermore, embodiments of the invention require only a single instantiation of an operating system running on the virtual machine rendering server and an operating system emulation layer running on each virtual machine game server to service multiple clients and multiple virtual machine game servers.

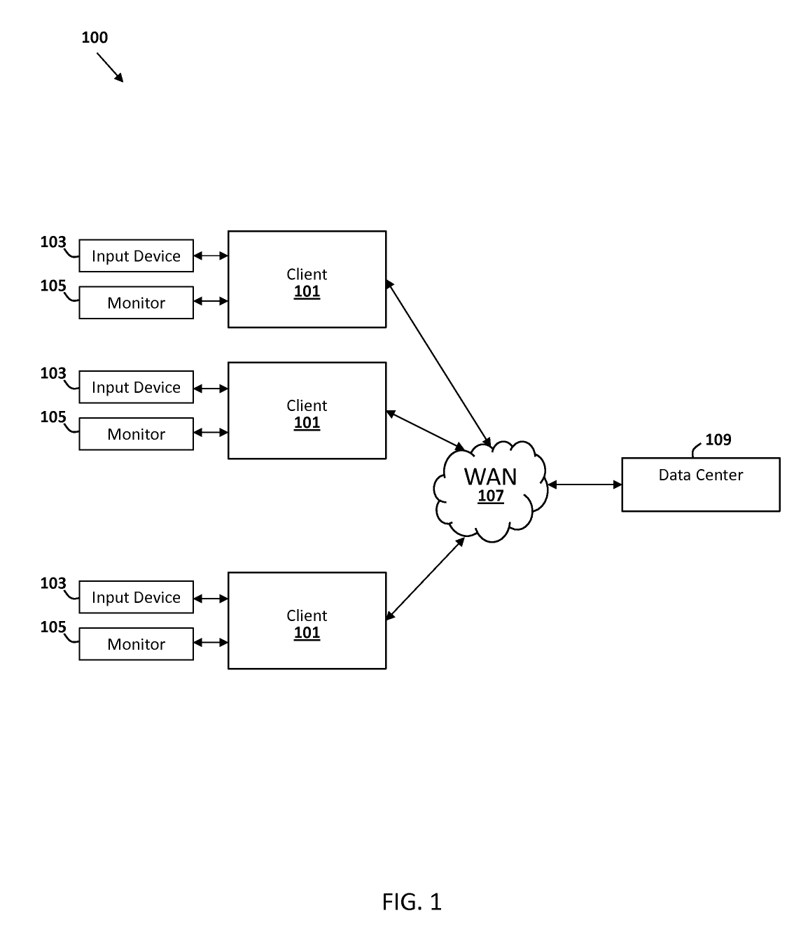

Remote rendering may be accomplished using a client-data center architecture, wherein one or more client devices may interact with games running on a data center by way of a network. FIG. 1 illustrates a typical client-data center architecture 100, wherein a plurality of clients 101 are connected to a data center 109 over a wide area network (WAN) 107. The data center 109 and client devices 101 may all be located in different geographical locations. Each game binary (e.g., game program) resides on the data center 109. Each client 101 may have an input device 103 and monitor 105. Such input devices may include keyboards, joysticks, game controllers, motion sensors, touchpads, etc. The client 101 interacts with the game binary by sending inputs to the data center 109 using its respective input device 103. The data center 109 processes the client's inputs (e.g., using a CPU) and renders video images (e.g., using a GPU) in accordance with the client inputs. The rendered images are then transmitted to the client device 101 where they may be displayed on the monitor 105. By implementing remote graphics rendering, the workload of the client device 101 may be significantly reduced as the majority of the processing (e.g., CPU processing and GPU processing) is performed at the data center 109 rather than at the client 101.

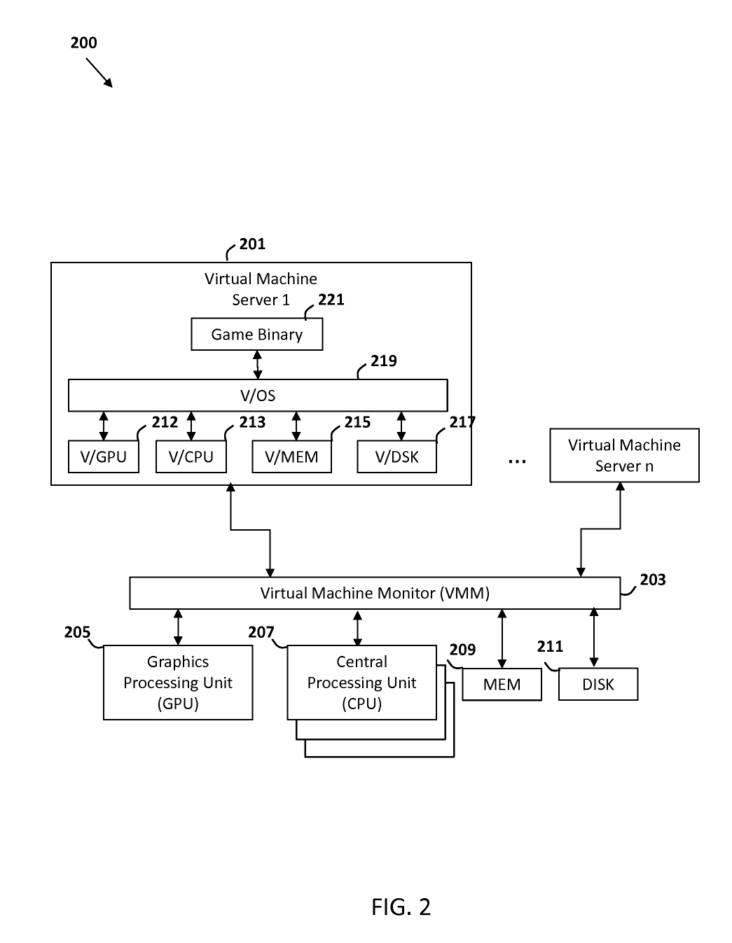

Remote graphics rendering may be implemented using virtualization of hardware resources at the data center to service different client devices. An approach for virtualizing hardware resources is illustrated in FIG. 2. FIG. 2 illustrates a data center architecture used to implement remote graphics rendering. The data center 200 utilizes a plurality of virtual machine servers 201 to facilitate remote graphics rendering. As is well known in the field of computer science, a virtual machine is a software abstraction—a “virtualization” of an actual computer system.

The typical data center 200 includes an underlying hardware system comprising a hardware processor (e.g., CPU) 207, a graphics processor (e.g., GPU) 205, a memory 209, and a storage device which will typically be a disk 211. The memory 209 will typically be some form of high-speed RAM, whereas the disk 211 will typically be a non-volatile, mass storage device.

Each virtual machine server 201 will typically include a virtual GPU 212, virtual CPU 213, a virtual memory 215, a virtual disk 217, a virtual operating system 219, and a game binary 221. All of the components of the virtual machine server 201 may be implemented in software using known techniques to emulate the corresponding components of the underlying hardware system. The game binary 221 running within a virtual machine server 201 will act just as it would if run on a “real” computer. Executable files will be accessed by the virtual operating system 219 from the virtual disk 217 or virtual memory 215, which will simply be portions of the actual physical disk 211 or memory 209 allocated to that virtual machine server 201.

The virtual machine server 201 may be functionally connected to a virtual machine monitor 203, which is functionally connected to the underlying hardware system. The virtual machine monitor 203 is a thin piece of software that runs directly on top of the hardware system and virtualizes the underlying hardware system. The virtual machine monitor 203 provides an interface that is responsible for executing virtual machine server 201 issued instructions and transferring data to and from the actual memory 209 and storage device 211. The game binary 221 may generate a set of instructions to be executed by either the virtual GPU 212 or the virtual CPU 213, which are conveyed to the underlying GPU 205 and CPU 207 using the virtual machine monitor 203.

In such a data center architecture 200, the underlying hardware system of the data center architecture 200 is shared by each virtual machine server 201. When servicing a multitude of clients, the data center 200 may exhaust one or more of the underlying hardware resources (e.g., GPU or CPU) of the hardware system. When this occurs, additional underlying hardware resources may be necessary in order to support the additional virtual machine servers required to service new clients. However, for the data center 200 described in FIG. 2, an entire hardware system including both a GPU and CPU must be added in order to support the functionality of the extra virtual machine servers. This may be undesirable where only the GPU is exhausted or only the CPU is exhausted because of the inefficient use of underlying hardware resources that may result. Said otherwise, once a single hardware resource (e.g., CPU or GPU) is exhausted, an entire hardware system must be added to support additional virtual machine servers regardless of whether or not some hardware resources (e.g., CPU or GPU) of the existing hardware system are available for servicing additional clients.

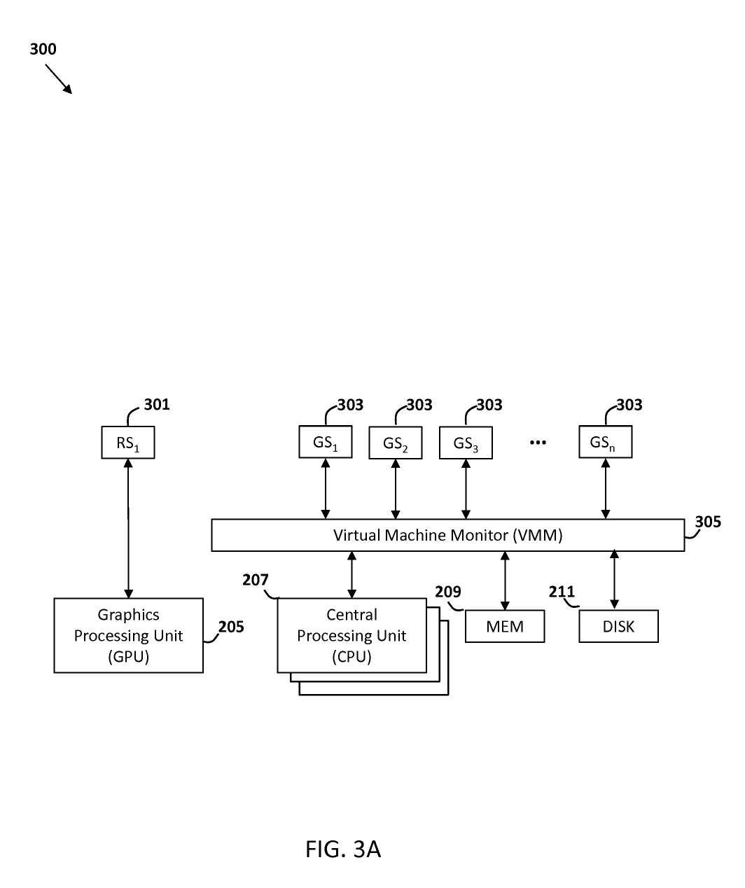

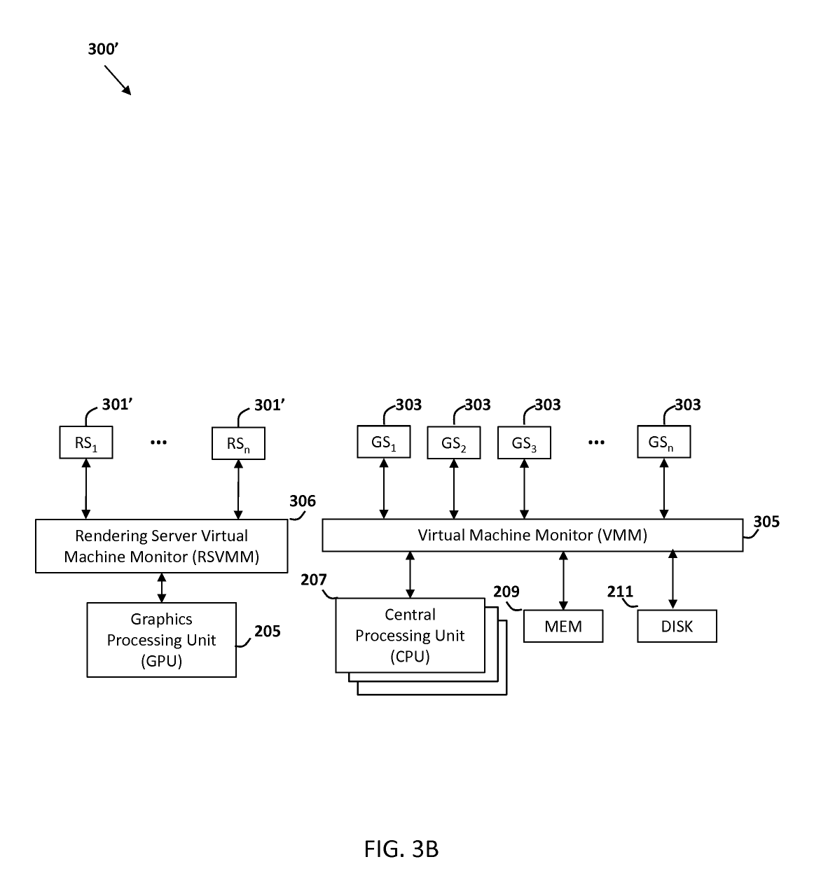

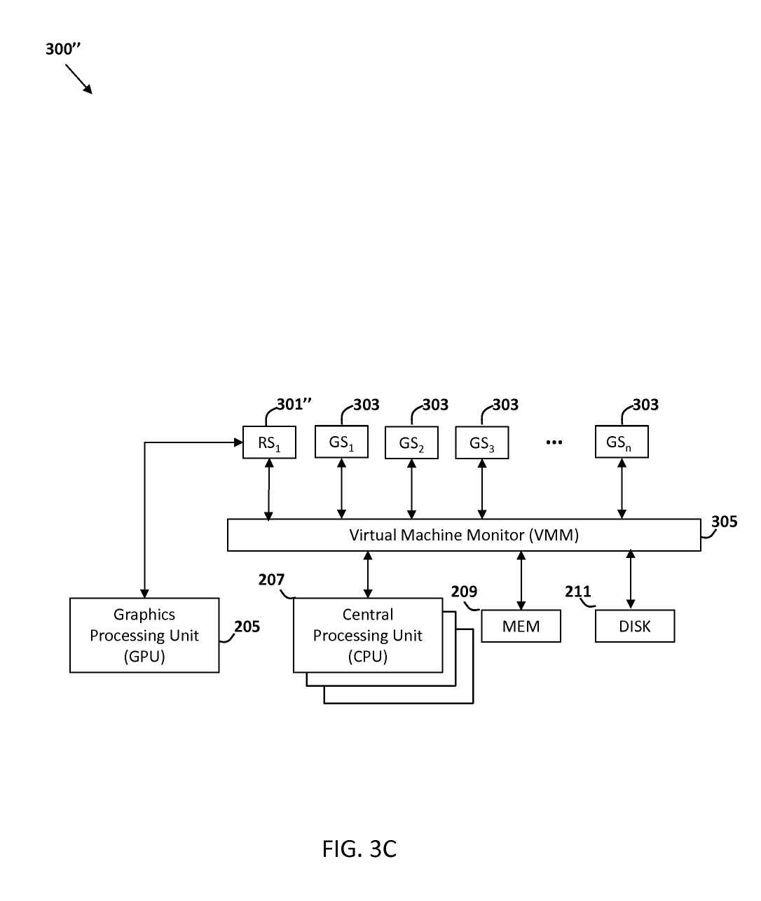

An example data center architecture that provides efficient scalability will now be described with reference to FIG. 3A which shows a block diagram of the data center architecture 300 in accordance with some embodiments. The data center architecture 300 comprises underlying hardware including a graphics processing unit (GPU) 205, a central processing unit (CPU) 207, a memory 209, and a disk 211. The GPU 205 and CPU 207 may be housed in separate physical machines. The CPU 207 may include multiple processing cores, with each processing core capable of executing multiple threads. A physical rendering server 301 is functionally connected to the GPU 205 and a plurality of virtual machine game servers 303 are functionally connected to a virtual machine monitor 305, which is functionally connected to the CPU 207, memory 209, and disk 211. The virtual machine monitor 305 is not functionally connected to the GPU 303. The data center architecture 300 may be configured such that the virtual machine monitor 305 is functionally connected to the CPU 207 and not the GPU 205 by simply directing the virtual machine monitor 305 to ignore the existence of the GPU 205 upon initialization. In such embodiments, the physical rendering server 301 and each of the plurality of virtual machine game servers 303 may communicate over an external network (not shown). The physical rendering server 301 may access the memory 209 and disk 211 independently of the virtual machine monitor 305.

While only a single VMM 305 is depicted in FIG. 3A, it is important to note that the data center may support a plurality of VMMs 305, with each VMM 305 supporting a plurality of virtual machine game servers 303 and each VMM 305 functionally connected to a separate CPU, memory, and disk.

Additionally, while only a single physical rendering server connected to the GPU is depicted, in some other embodiments, the data center architecture may be configured such that GPU may be virtualized to support a number of virtual machine rendering servers as illustrated in FIG. 3B. FIG. 3B illustrates such a data center architecture 300′. In such embodiments, a rendering server virtual machine monitor 306 may be functionally connected to the GPU 205 and a number of virtual machine rendering servers 301′ may be functionally connected to the rendering server virtual machine monitor 306. In such embodiments, the virtual machine game servers 303 and virtual machine rendering servers 301′ may continue to communicate over an external physical network. Even where the GPU 205 is virtualized, the VMM 305 functionally connected to the game servers 303 is not functionally connected to the GPU 305.

Again, while only a single VMM 305 is depicted in FIG. 3A, it is important to note that the data center may support a plurality of VMMs 305 may, with each VMM 305 supporting a plurality of virtual machine game servers 303 and each VMM 305 functionally connected to a separate CPU, memory, and disk.

In other embodiments, the data center architecture may include a virtual machine rendering server configured to perform GPU processing for clients that is functionally connected to the virtual machine monitor supporting the plurality of virtual machine game servers. FIG. 3C illustrates a block diagram of another example data center architecture 300″ in accordance with some other embodiments. The data center architecture 300″ of FIG. 3C comprises underlying hardware including a graphics processing unit (GPU) 205, a central processing unit (CPU) 207, a memory 209, and a disk 211. Again, the GPU 205 and CPU 207 may be housed in separate physical machines. The CPU 207 may include multiple processing cores, with each processing core executing multiple threads. A virtual machine rendering server 301″ and a plurality of virtual machine game servers 303 are functionally connected to a virtual machine monitor 305, which is functionally connected to the CPU 207, memory 209, and disk 211. The virtual machine rendering server 301″ is also functionally connected to the GPU 303, which is not functionally connected to the virtual machine monitor 305. Again, the data center architecture 300″ may be configured such that the virtual machine monitor 305 is functionally connected to the CPU 207 and not the GPU 205 by simply directing the virtual machine monitor 305 to ignore the existence of the GPU 205 upon initialization. The virtual machine rendering server 301″ may directly access the GPU using a direct pass solution, such as for example, Intel VT-d, AMD IOMMU, or ESx Directpath. In such embodiments, the virtual machine rendering server 301″ and each of the plurality of virtual machine game servers 303 may communicate over a virtual network by way of the virtual machine monitor 305.

Again, while only a single VMM 305 is depicted in FIG. 3C, a plurality of additional VMMs 305 may exist, with each additional VMM 305 supporting a plurality of additional virtual machine game servers 303 and each additional VMM 305 functionally connected to a CPU, memory, and disk. The additional virtual machine game servers may communicate with the virtual machine rendering server 301″ over an external physical network (not shown) rather than over a virtual network by way of the virtual machine monitor.

In the data center architectures 300, 300′, 300″ of FIGS. 3A and 3B, the rendering server (physical or virtual) 301, 301′, 301″ is configured to perform all GPU processing and the virtual machine game servers 303 are configured to perform all CPU processing for clients interacting with the data center 300, 300′, 300″. This is in contrast to the prior approach described in FIG. 2, wherein a virtual machine server performs both GPU processing and CPU processing for clients interacting with the data center.

The term “rendering server” will be used hereinafter to describe both a “physical rendering server” and a “virtual machine rendering server” unless explicitly stated otherwise.

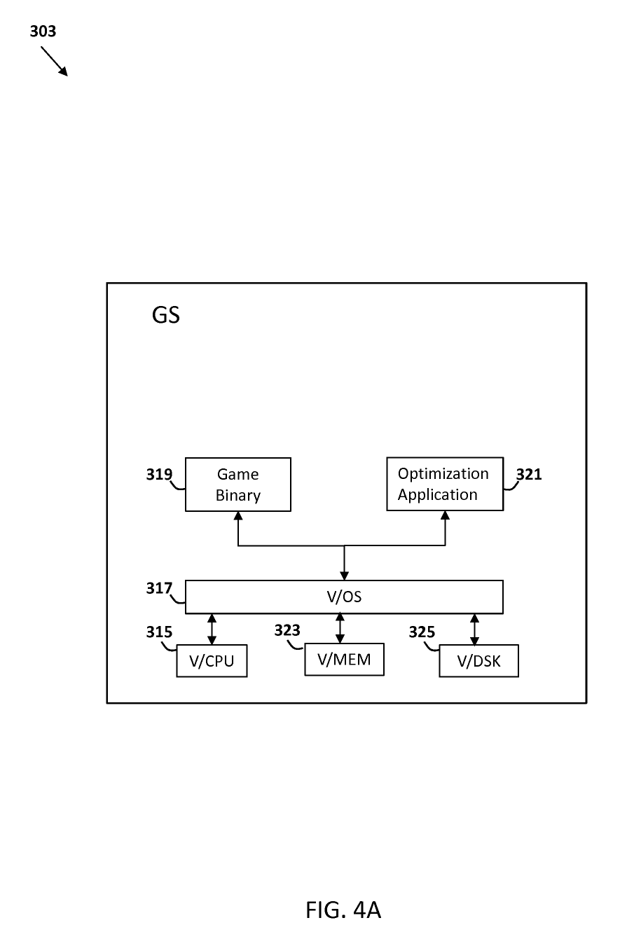

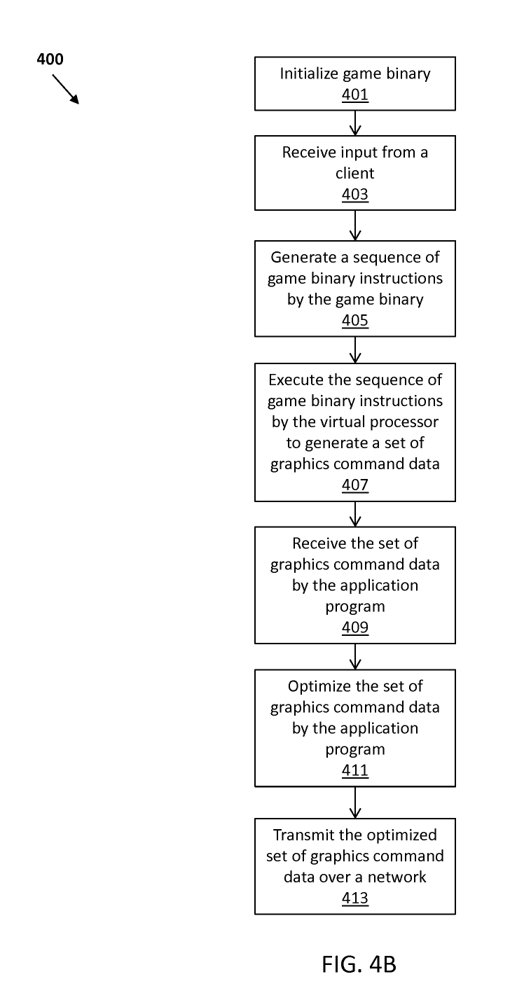

FIG. 4A illustrates a virtual machine game server 303 as discussed above in FIGS. 3A, 3B, and 3C in accordance with some embodiments. Each virtual machine game server 303 includes a virtual processor 315, a virtual memory 323, a virtual disk 325, a virtual operating system 317, a game binary 319, and may also optionally include an optimization application program 321. Each virtual machine game server 303 in FIG. 4A corresponds to a particular client that is interacting with the data center, but it is important to note that in other embodiments each virtual machine game server 303 may correspond to more than one client. To coordinate interaction between a client and a virtual machine game server 303, the data center may initialize a virtual machine game server 303 and assign it to a particular client when the client requests to engage in gameplay using the data center. The client may then be provided a particular address associated with its corresponding virtual machine game server 303 in order to facilitate communication.

FIG. 4B is a flow diagram illustrating a method 400 for utilizing a virtual machine game server according to some embodiments. The virtual machine game server 303 first initializes a game binary 319 (e.g., game program) corresponding to the game selected by the corresponding client as described in step 401. The game binary 319 may run under the control of the virtual operating system 307 and may generate a sequence of game binary instructions corresponding to the current state of the game. Such binary instructions may be processed and converted into a sequence of images to be displayed to the client, which will be discussed in more detail below.

The virtual machine game server 303 is configured to receive input from the client to facilitate interaction between the client and the game binary 319. In step 403, the virtual machine game server 303 receives input from an input device associated with its corresponding client. Such input devices may include keyboards, joysticks, game controllers, motion sensors, touchpads, etc. as described above. Once the virtual machine game server 303 has received the input from the client, the game binary 319 generates a sequence of game binary instructions as described in step 405.

The game binary instructions are then executed by the virtual processor 315 to generate a set of graphics command data as described in step 407. The game binary instructions are conveyed by the virtual machine monitor 305 to the underlying CPU 207, where physical execution of the game binary instructions is carried out by the CPU 207. When executing the game binary instructions, the virtual machine game server 303 may utilize the virtual memory 323 and virtual disk 325 to transfer data to and from the actual memory 209 and storage device 211.

In some embodiments, the graphics command data generated by the virtual processor 315 may be intercepted by an optimization application program 321, as described in step 409. The optimization application program 321 may be configured to perform optimization on the set of graphics command data. In step 411, the application program 321 may optionally optimize the set of graphics command data. Such optimization may include eliminating some or all data that is not needed to render one or more images, applying precision changes to the set of graphics command data, or performing one or more data type compression algorithms on the set of graphics command data. Techniques for performing optimization on the set of graphics command data may be found in patent application Ser. No. 13/234,948, which is herein incorporated by reference in its entirety. Optimizing the set of graphics command data allows for the rendering of images associated with the set of graphics command data to be performed more efficiently.

The optimized set of graphics command data may then be transmitted over a network to the rendering server 301 as described in step 413. As discussed above, the network may be an external physical network or a virtual network, depending on the particular data center architecture involved.

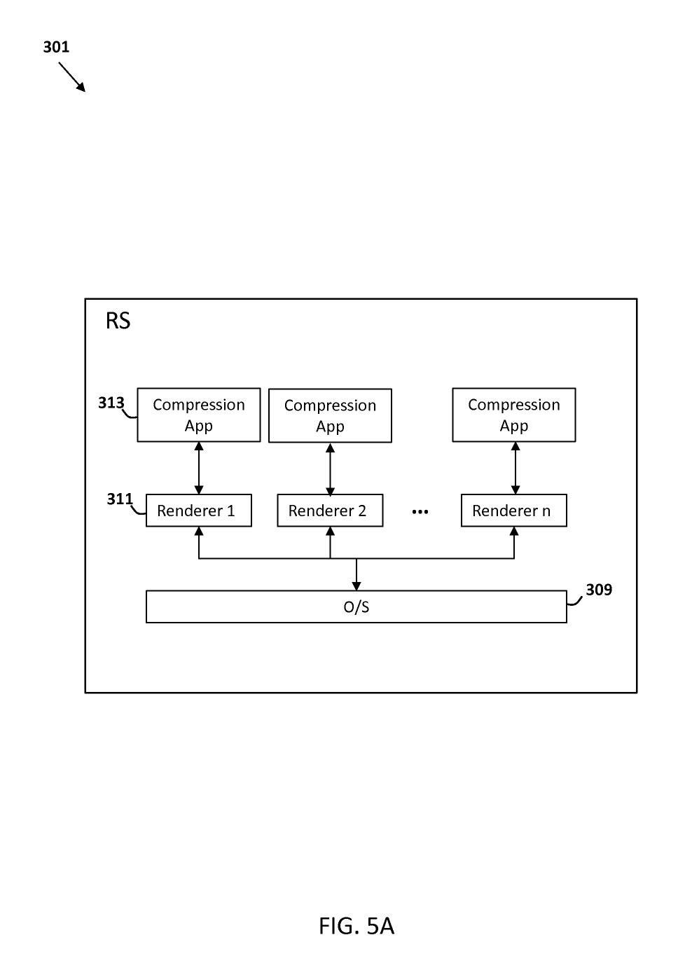

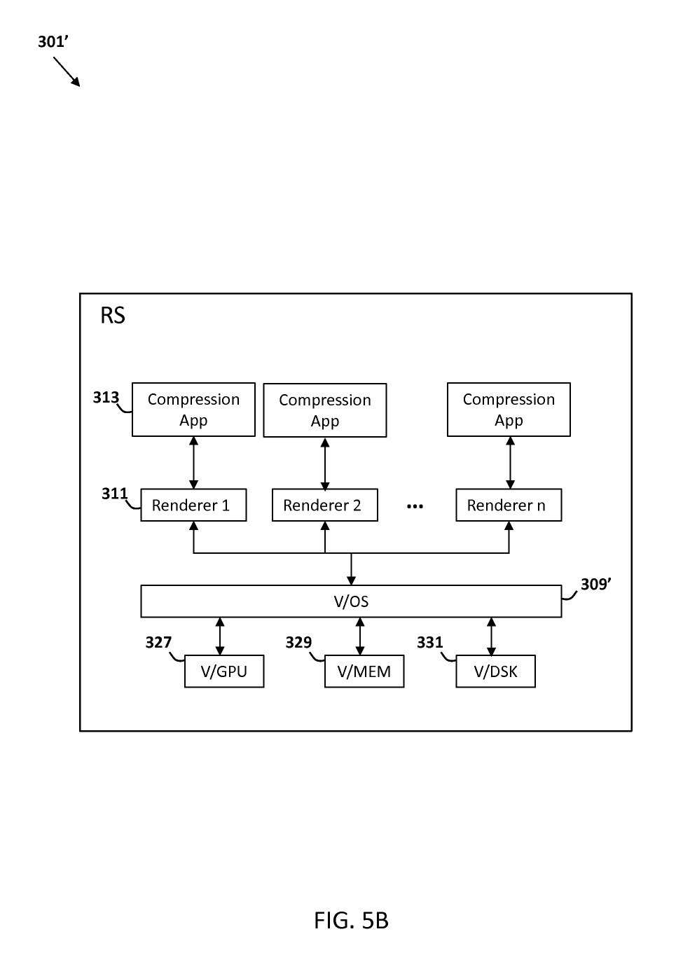

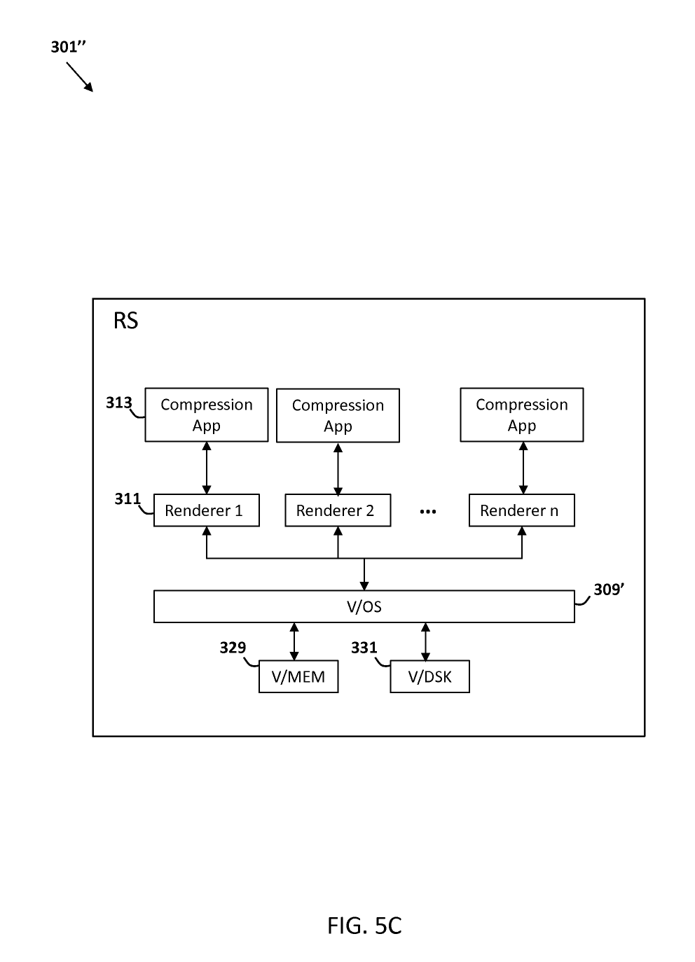

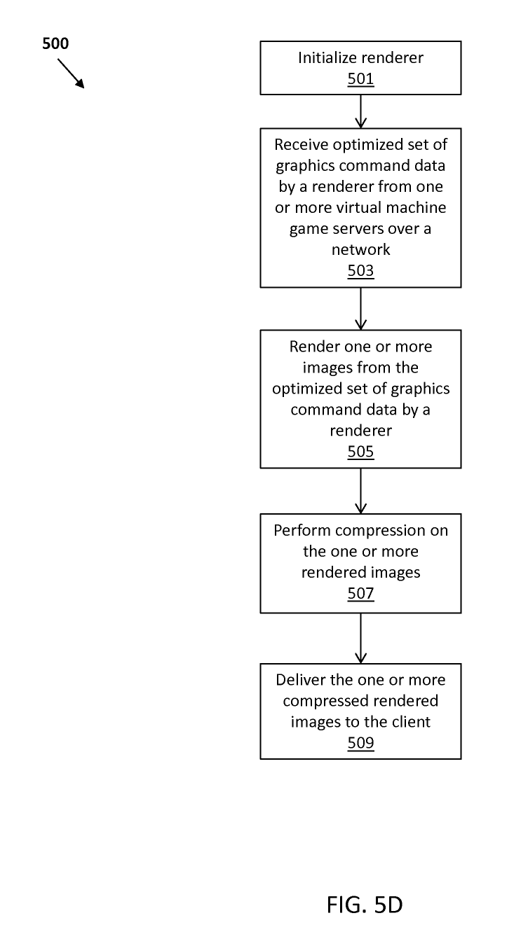

FIG. 5A illustrates a physical rendering server 301 as discussed above in FIG. 3A in accordance with some embodiments according to some embodiments. The physical rendering server 301 includes an operating system and one or more renderers 311, and optionally includes a video compression application 313 associated with each renderer 311. In some embodiments, each renderer 311 may correspond to a particular virtual machine game server 303 and client(s) associated with that particular virtual machine game server. In other embodiments, each renderer 311 may correspond to more than one game server and the client(s) associated with said game servers. To coordinate interaction between clients, renderers 311, and virtual machine game servers 303, a data center 300 may initialize a renderer 311 within the physical rendering server 301 and assign it to a particular client and game server 303 associated with the client. The virtual machine game server 303 may be provided a particular address associated with its corresponding renderer 311, and may communicate with the corresponding renderer 311 using that address. Similarly, the renderer 311 may be provided a particular address associated with the client, and may communicate with the client using that address. The renderer 311 is configured to perform GPU processing, which will be discussed in detail below.

FIG. 5B illustrates a virtual machine rendering server 301′ as discussed above in FIG. 3B according to some embodiments. The virtual machine rendering server 301′ includes a virtual operating system 309′, a virtual GPU 327, a virtual memory 329, a virtual disk 331, and one or more renderers 311, and optionally includes a video compression application 313 associated with each renderer 311. The virtual GPU 327 may execute instructions by conveying instructions to the underlying GPU 205 using the rendering server virtual machine monitor (RSVMM) 306.

In some embodiments, each renderer 311 may correspond to a particular virtual machine game server 303 and client(s) associated with that particular virtual machine game server. In other embodiments, each renderer 311 may correspond to more than one game server and the client(s) associated with said game servers. To coordinate interaction between clients, renderers 311, and virtual machine game servers 303, a data center may initialize a renderer 311 within the virtual machine rendering server 301′ and assign it to a particular client and game server 303 associated with the client. The virtual machine game server 303 may be provided a particular address associated with its corresponding renderer 311, and may communicate with the corresponding renderer 311 using that address. Similarly, the renderer 311 may be provided a particular address associated with the client, and may communicate with the client using that address.

FIG. 5C illustrates a virtual machine rendering server 301″ as discussed above in FIG. 3C according to some embodiments. The virtual machine rendering server 301″ includes a virtual operating system 309′, a virtual memory 329, a virtual disk 331, and one or more renderers 311, and optionally includes a video compression application 313 associated with each renderer 311. In some embodiments, each renderer 311 may correspond to a particular virtual machine game server 303 and client(s) associated with that particular virtual machine game server. In other embodiments, each renderer 311 may correspond to more than one game server and the client(s) associated with said game servers. To coordinate interaction between clients, renderers 311, and virtual machine game servers 303, a data center may initialize a renderer 311 within the virtual machine rendering server 301″ and assign it to a particular client and game server 303 associated with the client. The virtual machine game server 303 may be provided a particular address associated with its corresponding renderer 311, and may communicate with the corresponding renderer 311 using that address. Similarly, the renderer 311 may be provided a particular address associated with the client, and may communicate with the client using that address.

FIG. 5D is a flow diagram illustrating a method 500 for utilizing a rendering server 301, 301′, 301″ according to some embodiments. Initially, a renderer 311 is initialized corresponding to a particular virtual machine game server 303 and client as described at 501. The renderer 311 is responsible for processing graphics command data and rendering a sequence of images associated with the graphics command data for a particular client.

In some embodiments, the renderer 311 may receive an optimized set of graphics command data from its associated virtual machine game server 303 over a network as described at 503. In other embodiments, the renderer 311 may receive a non-optimized set of graphics command data from its associated virtual machine game server 303 over a network. As discussed above, the data center may assign a renderer 311 to a particular virtual machine game server 303 and provide an address to the virtual machine game server 303 to facilitate communication with the renderer 311 of the rendering server 301, 301′, 301″.

The renderer 311 may then render one or more images from the optimized/non-optimized set of graphics command data received as described in step 505. In rendering one or more images from the set of graphics command data, the renderer 311 conveys graphics command data to the GPU 205 which physically executes the graphics command data to generate the one or more images. In the rendering server 301′ of FIG. 5B, graphics command data may be conveyed from the renderer 311 to the virtual GPU 327, which then conveys the graphics command data to the underlying GPU 205 for execution. In the rendering server 301, 301″ of FIGS. 5A and 5C, graphics command data may be conveyed directly to the underlying GPU 205 for execution.

The renderer 311 of the rendering server 301, 301′, 301″ may then optionally perform compression on the one or more rendered images using the video compression application as described in step 507. Compression reduces the bandwidth required to transmit the images to the client for display. However, compression sometimes results in loss of visual quality, and as such may not be desired for certain games.

After the one or more images have been rendered and optionally compressed, those images may then be transmitted to the client as described in step 509. As discussed above, the data center may assign a renderer 311 to a particular client and identify an address by which the renderer 311 may communicate with the client.

By performing game processing (e.g., generating game binary instructions and image rendering) at a remote data center, the complexity of a client device may be significantly reduced, as the majority of the workload is performed by the remote data center.

More importantly, by separating the data center 300, 300′, 300″ into a rendering server 301, 301′, 301″ that provides GPU processing and a plurality of virtual machine game servers 303 that provide CPU processing, a more flexible data center architecture may be achieved. Whereas the typical data center architecture has a single virtual machine server to execute game binary instructions and to render images for a particular client, the data center architectures 300, 300′, 300″ illustrated in FIGS. 3A, 3B, and 3C utilize a virtual machine game server 303 to execute game binary instructions for a particular client and a rendering server 301, 301′, 301″ to render images for a plurality of virtual machine game servers 303 and their associated clients. In this way, the data center architecture is configurable and capable of independently scaling the number of GPUs 205 or CPUs 207 needed.

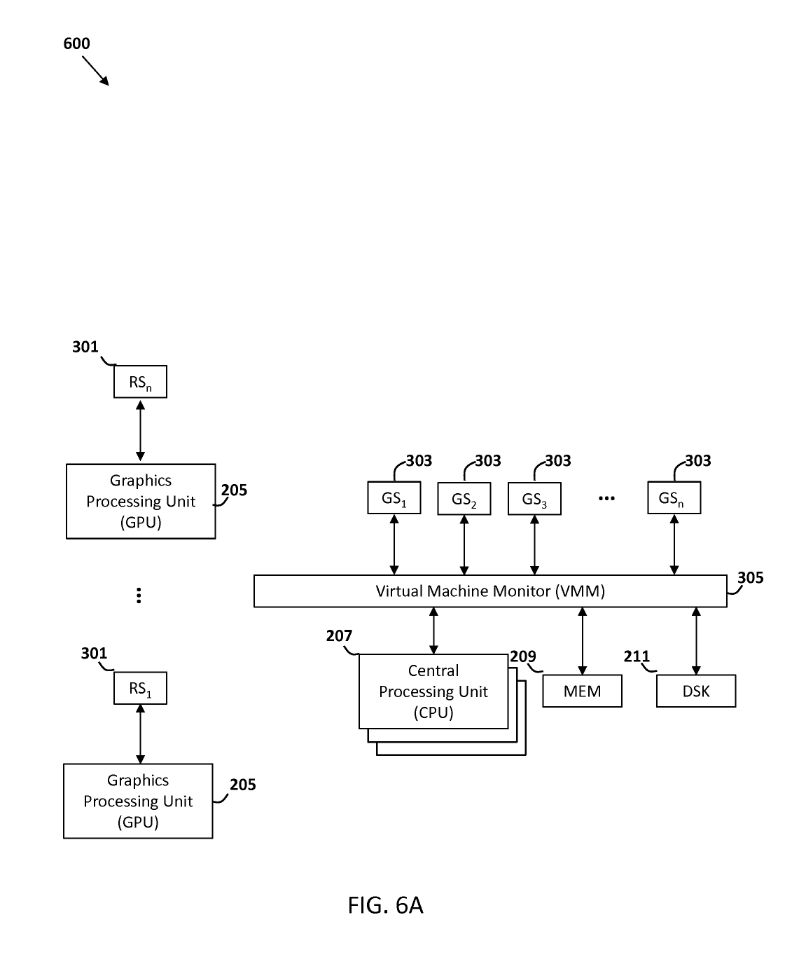

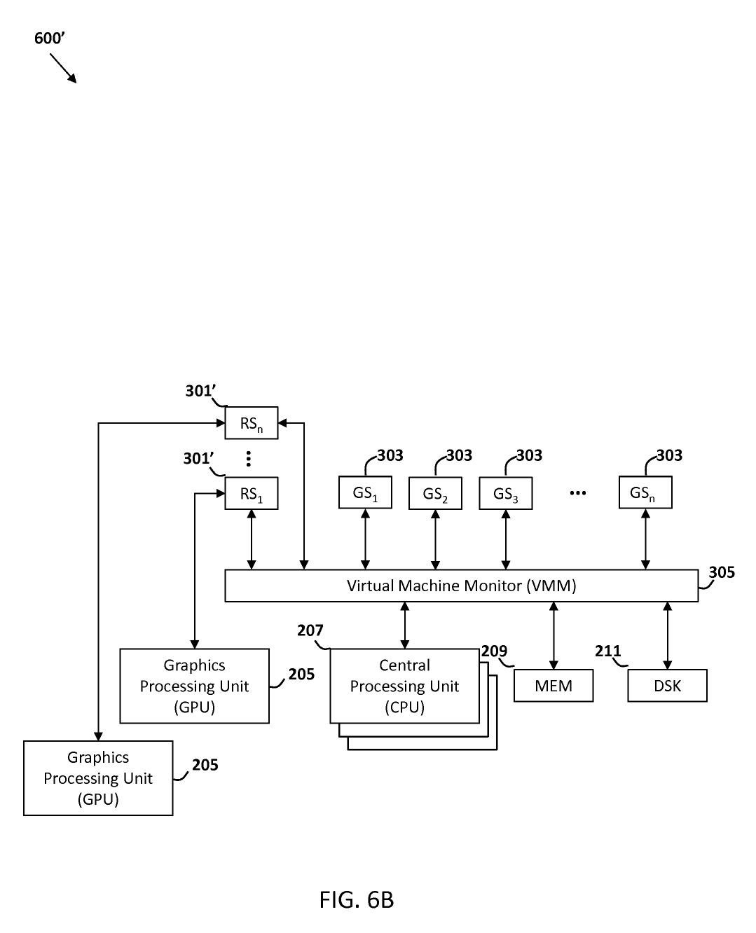

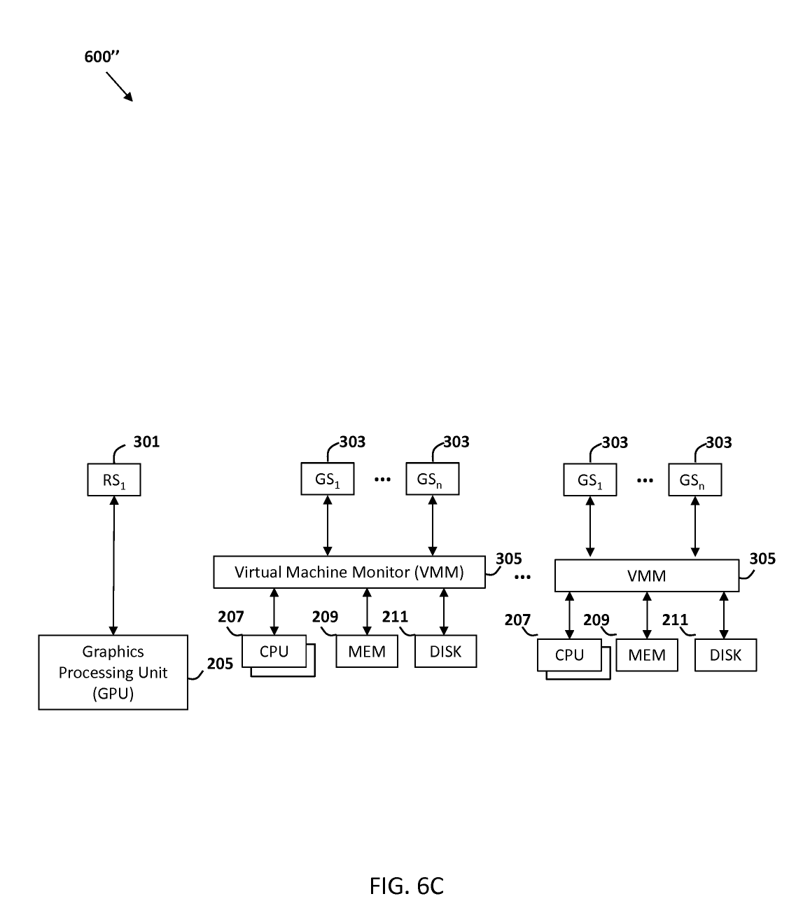

FIG. 6A illustrates a selective configuration 600 of the data center architecture of FIG. 3A according to some embodiments. FIG. 6A illustrates the data center of FIG. 3A selectively configured to add one or more GPUs 205 and one or more corresponding physical rendering servers 301 functionally connected to the one or more GPUs 205. When the GPU 205 has reached its maximum capacity and the CPU 207 is still capable of servicing more clients, the data center 600 may be selectively configured to add one or more GPUs 205 and one or more corresponding physical rendering servers 301 functionally connected to the one or more additional GPUs 205 in order to adequately service clients. Thus, additional GPUs 205 may be added to support rendering for additional clients without also requiring the addition of a CPU 207 where the existing CPU 207 is still capable of servicing additional clients. Such an architecture 600 may be desirable where the data center is servicing several clients running graphics-intensive games that require heavy use of GPU 205 resources.

FIG. 6B illustrates a selective configuration 600′ of the data center architecture of FIG. 3B according to some embodiments. FIG. 6B illustrates the data center of FIG. 3B selectively configured to add one or more GPUs 205 and one or more corresponding virtual machine rendering servers 301′ functionally connected to the one or more GPUs 205. When the GPU 205 has reached its maximum capacity and the CPU 207 is still capable of servicing more clients, the data center 600′ may be selectively configured to add one or more GPUs 205 and one or more corresponding virtual machine rendering servers 301′ functionally connected to the one or more additional GPUs 205 in order to adequately service clients. Thus, additional GPUs 205 may be added to support rendering for additional clients without also requiring the addition of a CPU 207 where the existing CPU 207 is still capable of servicing additional clients. Such an architecture 600′ may be desirable where the data center is servicing several clients running graphics-intensive games that require heavy use of GPU 205 resources.

FIG. 6C illustrates another selective configuration 600″ of the data center architecture of FIG. 3A according to some embodiments. FIG. 6C illustrates the data center of FIG. 3A selectively configured to add one or more CPUs 207, one or more corresponding virtual machine monitors 305, and one or more virtual machine game servers 303 functionally connected to the corresponding one or more virtual machine monitors 305. When the CPU 207 has reached its maximum capacity and the GPU 205 is still capable of servicing more clients, the data center 600″ may be selectively configured to add one or more CPUs 207, one or more corresponding virtual machine monitors 305, and one or more virtual machine game servers 303 functionally connected to the corresponding one or more virtual machine monitors 305. Here, additional CPUs 207 may be added to support execution of game binary instructions without also requiring the addition of a GPU 205 where the existing GPU 205 is still capable of servicing the additional clients. Such an architecture 600″ may be desirable where the data center 600″ is servicing several clients running CPU-intensive games that require heavy use of CPU 207 resources.

An additional advantage also arises from implementing the data center architecture described above. The data center architecture 200 described in FIG. 2, includes several virtual machine servers 201 wherein each virtual machine server 201 provides both game processing and image rendering functionality. Each virtual machine server 201 in the typical architecture implements an instantiation of a virtual operating system to facilitate communication between the game and the underlying hardware. However, many operating systems require a license fee for each instantiation, and so each virtual machine server would require a fee to run an instance of the operating system. For example, each virtual machine server running a game on the Windows platform would require a separate licensing fee. To reduce costs, each virtual machine server may instead run a free underlying operating system, such as for example, Linux, and an operating system emulation layer (e.g., Windows emulation layer) on top of the underlying operating system. The operating system emulation layer provides an interface for communicating between the game (which is configured to operate under the emulated operating system) and the underlying operating system. For hardware processor instructions, the operating system emulation layer provides a satisfactory medium for communicating between the game binary and the underlying operating system. However, for graphics processor instructions, the emulation layer is quite error-prone and often mistranslates graphics processor instructions to the underlying operating system. Thus, using an emulation layer for each virtual machine server would not allow for adequate operation in the data center architecture described in FIG. 2.

However, in the data center architecture described above with respect to FIGS. 3A 3B, and 3C where the virtual machine game servers and rendering servers are separated, use of an emulation layer for each virtual machine game server may still allow for adequate operation while at the same time reducing overall implementation costs. Because each virtual machine game server only services hardware processor instructions, using an operating system emulation layer and a free underlying operating system is satisfactory for communicating between the game and the underlying operating system. A licensed version of the emulated operating system may then be purchased for the rendering server(s) where the actual operating system is necessary to service graphics processor instructions. The proposed architecture allows each virtual machine game server to use an operating system emulation layer, while only the rendering server(s) requires a licensed version of the emulated operating system to service the plurality of virtual machine game servers. Thus, rather than having to license an instantiation of the operating system for each virtual machine server, as is the case with the typical architecture, only rendering servers require an instantiation of the operating system to service multiple clients and multiple virtual machine game servers.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

What is claimed is:

1. A data center architecture for remote rendering comprising:
a hardware processor;
a memory;
a storage device;
a graphics processor;
a virtual machine monitor functionally connected to the hardware processor, memory, and storage device;
one or more virtual machine game servers functionally connected to the virtual machine monitor, each virtual machine game server comprising:
a virtual processor;
a virtual memory;
a virtual storage;
a virtual operating system;
a game binary executing under the control of the virtual operating system;
a rendering server connected to the graphics processor, the rendering server comprising:
an operating system; and
one or more renderers.

2. The data center architecture of claim 1, wherein the data center architecture is configurable and may be selectively configured to:
add one or more graphics processors and one or more corresponding rendering servers functionally connected to the one or more graphics processors; or
add one or more hardware processors, one or more corresponding virtual machine monitors, and one or more virtual machine game servers functionally connected to the corresponding one or more virtual machine monitors.

3. The data center architecture of claim 1, wherein each virtual machine game server is configured to:
receive input from a client associated with the virtual machine game server;
generate a sequence of game binary instructions with the game binary according to the received input;
execute the sequence of game binary instructions generated by the game binary with the virtual processor to generate a set of graphics command data; and
transmit the set of graphics command data over a network.

4. The data center architecture of claim 3, wherein each virtual machine game server further comprises an optimization application executing under the control of the virtual operating system, the optimization application performing optimization of the set of graphics command data generated by the virtual processor prior to transmitting the set of graphics command data over the network.

5. The data center architecture of claim 4, wherein performing optimization of the set of graphics command data generated by the virtual processor involves eliminating some or all data that is not needed by the one or more renderers to render one or more images.

6. The data center architecture of claim 4, wherein performing optimization of the set of graphics command data generated by the virtual processor involves applying precision changes to the set of graphics command data.

7. The data center architecture of claim 4, wherein performing optimization of the set of graphics command data generated by the virtual processor involves performing one or more data type compression algorithms on the set of graphics command data.

8. The data center architecture of claim 1, wherein each renderer of the virtual machine rendering server is configured to:
receive a set of graphics command data from the one or more virtual machine game servers over a network;
render one or more images from the set of graphics command data; and
transmit the one or more images to a client associated with the renderer.

9. The data center architecture of claim 8, wherein each renderer further comprises a compression application, the compression application configured to compress the one or more rendered images prior to transmitting the one or more images to the client.

10. The data center architecture of claim 1, wherein the rendering server is a virtual machine rendering server also functionally connected to the virtual machine monitor.

11. The data center architecture of claim 10, wherein the virtual machine rendering server comprises a virtual memory, a virtual disk, and wherein the operating system is a virtual operating system.

12. The data architecture of claim 10, wherein the virtual machine rendering server is configured to directly access the graphics processor using a direct pass solution.

13. The data architecture of claim 12, wherein the direct pass solution includes: Intel VT-d, AMD IOMMU, or ESx Directpath.

14. The data architecture of claim 1, wherein each virtual machine game server further comprises an operating system emulation layer.

15. A configurable data center architecture for remote rendering, wherein the data center architecture is configured to:
perform GPU processing using one or more graphics processors;
perform CPU processing using one or more hardware processors; and
wherein the configurable data center architecture may be selectively configured to:
independently add one or more graphics processors to provide GPU processing for servicing a plurality of clients interacting with the data center; or
independently add one or more hardware processors to provide CPU processing for a servicing the plurality of clients interacting with the data center.

16. In a data center architecture for remote rendering comprising:
a hardware processor;
a memory;
a storage device;
a graphics processor;
a virtual machine monitor functionally connected to the hardware processor, memory, and storage device;
one or more virtual machine game servers functionally connected to the virtual machine monitor, each virtual machine game server comprising:
a virtual processor;
a virtual memory;
a virtual storage;
a virtual operating system;
a game binary executing under the control of the virtual operating system;
a rendering server functionally connected to the graphics processor, the rendering server comprising:
an operating system;
one or more renderers;
a method comprising the following steps:
receiving input from a client at a virtual machine game server of the one or more virtual machine game servers;
generating a sequence of game binary instructions with the game binary of the virtual machine game server in accordance with the received input;
executing the sequence of game binary instructions generated by the game binary with the virtual processor of the virtual machine game server to generate a set of graphics command data;
transmitting the set of graphics command data over a network by the virtual machine game server;
receiving the set of graphics command data by a renderer of the rendering server corresponding to the virtual machine game server;
rendering one or more images from the set of graphics command data by the renderer; and
transmitting the one or more images to the client.

17. The method of claim 16, wherein each virtual machine game server further comprises an optimization application executing under the control of the virtual operating system, the optimization application performing optimization of the set of graphics command data generated by the virtual processor prior to transmitting the set of graphics command data over the network.

18. The method of claim 17, wherein performing optimization of the set of graphics command data generated by the virtual processor involves eliminating some or all data that is not needed by the one or more renderers to render one or more images.

19. The method of claim 17, wherein performing optimization of the set of graphics command data generated by the virtual processor involves applying precision changes to the set of graphics command data.

20. The method of claim 17, wherein performing optimization of the set of graphics command data generated by the virtual processor involves performing one or more data type compression algorithms on the set of graphics command data.

21. The method of claim 16, wherein each renderer further comprises a compression application, the compression application configured to compress the one or more rendered images prior to transmitting the one or more images to the client.
